(19) United States
(12) Patent Application Publication
(10) Pub. No.: US 2024/0189923 A1
(43) Pub. Date: Jun. 13, 2024

(54) Methods, system and electronic module for counterbalancing a weight force of an object

(71) Applicant: Hilti Aktiengesellschaft, Schaan (LI)

(72) Inventors: Roland SCHAER, Grabs (CH); Michael WIERER, Rothis (AT); Dragan STEVIC, Feldkirch-Testers (AT); Georg BRAML, Landsberg (DE); Christian METZLER, Satteins (AT); Antonios DRAGANIS, Tussenhausen (DE); Guenther VEIK, Maeder (AT)

(21) Appl. No.: 18/286,057

(22) PCT Filed: Apr. 4, 2022
(86) PCT No.: PCT/EP2022/058862

§ 371 Date: Oct. 6, 2023

(30) Foreign Application Priority Data
Apr. 22, 2021 (EP) 21169810.5

(51) Int. Cl. B23B 35/00; B66C 13/08

(52) U.S. Cl. CPC B23B 35/00; B66C 13/085

(57) ABSTRACT

Methods for counterbalancing a weight force of an object fastenable to a traction cable. A system is configured to carry out a counterbalancing operation with respect to the weight force of the object. This counterbalancing operation can be performed in that a rotational speed of the motor and/or a derivation of the rotational speed of the motor is determined, wherein a current setpoint value can be stored as a controlled variable in the system. The rotational speed of the motor or a derivation thereof corresponds to a weight force of the object. Alternatively, a current value required for maintaining the first position of the object or a motor torque required for this purpose can be stored in the system and the weight force of the object can be counterbalanced using the previously stored current values or torques. In further aspects, the invention relates to a system and to an electronic module.

The present invention relates to methods for counterbalancing a weight force of an object in a system, wherein the object can be fastened to a traction cable.

### BACKGROUND OF THE INVENTION

The use of power tools, such as chiseling devices, hammer drills, core drilling devices or the like, is often strenuous and tiring, especially when working with these devices for a relatively long period of time. Power tools are often heavy and the downward weight force of such a tool toward the ground means that work with such tools can only be performed for a limited period of time before a break is required. However, this can delay the progress of work on a construction site, which is undesirable for various reasons.

### SUMMARY OF THE INVENTION

Furthermore, working with heavy power tools for many years may lead to physical limitations. There is therefore a need to provide means that make working with heavy power tools easier and effectively protect the users of such power tools from adverse health effects.

Passive assistance systems, for example, are known in the prior art. In these passive assistance systems, an object can be fastened to a component of the assistance system, the object then being held by the assistance system. Especially when working with power tools that are to be fastened to an assistance system and with which work is sometimes carried out very dynamically, such a passive suspension cannot provide sufficient support for the user in some applications.

An object on which the present invention is based is therefore to overcome the above-described deficiencies and disadvantages of the prior art and to provide a method and a system for counterbalancing a weight force of an object that is particularly easy to handle. In addition, the system to be provided and the method are intended to effectively and reliably counterbalance the weight force of an object in different applications and situations. Experts would also appreciate it if the system to be provided could enable not only static but also dynamic support for the system user. A further object on which the invention is based is to provide an electronic module as the drive unit and control unit of such a system.

According to the invention, a method for counterbalancing a weight force of an object in a system is provided, wherein the object can be fastened to a traction cable, the method being characterized by the following method steps:
a) fastening the object to the traction cable,
b) determining a rotational speed of the motor and/or a derivation of the rotational speed of the motor,
c) determining a current setpoint value,
d) counterbalancing the weight force of the object using the previously determined current setpoint value.

It is preferred for the purposes of the invention that the rotational speed of the motor or a derivation thereof corresponds to the weight force of the object which is to be counterbalanced using the proposed method. The weight force of the object is counterbalanced in particular by using the previously determined current setpoint value as a controlled variable. For the purposes of the invention, this preferably means that the weight force of the object is counterbalanced by the motor current of the motor of the system being regulated to the current setpoint value. It is preferred for the purposes of the invention that the current setpoint value is determined when the rotational speed of the motor has fallen below a limit value for a relatively long period of time.

A current setpoint value S is determined for the purposes of the proposed method. In particular, that current value is defined as the current setpoint value at which the rotational speed of the motor or a derivation thereof falls below a previously defined limit value. It is preferred for the purposes of the invention that a present current value is defined as the current setpoint value and regulated fixedly thereto as soon as the object is fastened to the traction cable or hooked up to the system. The current setpoint value is determined in particular when the rotational speed of the motor and/or a derivation thereof falls below a limit value for a defined period of time. The current setpoint value determined in this way is then preferably used for counterbalancing the weight force of the object, wherein the current setpoint value in particular represents the control variable or controlled variable. The weight force of the object is thus counterbalanced in particular using the previously determined current setpoint value. It is preferred for the purposes of the invention that the motor current assumes a constant value essentially at all times when the weight of the object is to be counterbalanced. The wording that the current setpoint value is used “as a controlled variable” is not an unclear term for the person skilled in the art, because the person skilled in the art knows that this means regulation to this specific current value.

In the context of the proposed method, a present current setpoint value is recorded if the rotational speed of the motor of the system or a derivation thereof falls below a limit value. This current setpoint value is then used as the controlled variable, i.e. regulation thereto is carried out. As a result, the current setpoint value is preferably used in order to counterbalance the weight force of the object or the weight thereof.

It is preferred for the purposes of the invention that the rotational speed of the motor of the system correlates with a speed of the traction cable of the system. In other words, there is a correlation between the motor rotational speed of the system and the speed of the traction cable. To put it another way, the rotational speed of the motor corresponds to a speed of the traction cable of the system. In the context of the present invention, position control can be switched to if the rotational speed of the motor of the system exceeds a limit value. It is preferred for the purposes of the invention that the determination of a first position X of the object is preferably referred to as position control for the purposes of the invention. A position controller can advantageously be used for this purpose. It is preferred for the purposes of the invention that the position control is completed when a velocity of the object or the derivation of the velocity of the object assumes the value “zero” for a defined length of time.

In an alternative embodiment, the invention relates to a method for counterbalancing a weight force of an object in a system, wherein the object can be fastened to a traction cable, the method being characterized by the following method steps:
a) determining a present position of the object,
b) determining a rotational speed of the motor and/or a derivation of the rotational speed of the motor,
c) storing the present position as a controlled variable in the system if the rotational speed of the motor and/or the derivation of the rotational speed of the motor exceeds a limit value,
d) controlling the present position of the object until a velocity of the object is essentially “zero” for a period of time delta t,
e1) storing a current value I_X required for maintaining the present position in the system or
e2) storing a torque M_X required for maintaining the present position in the system,
f) counterbalancing the weight force using the current value I_X stored in step e1 or the torque M_X stored in step e2.

In this embodiment of the invention, it is preferred that the weight force of the object can be counterbalanced by regulating the previously determined or stored current and torque data. In this way, in particular, a possibility can be provided of working with the object essentially without any force, since, as a particular advantage of the invention, the weight force of the object is “removed” from the user of the system.

It is preferred for the purposes of the invention that the method controls the position of the object to a stored position until the position of the object is constant. A position of the object is preferably considered to be constant when its velocity is essentially 0 for a relatively long period of time. For the purposes of the invention, it can be preferred, for example, for such a time period delta t to be in a range from 50 to 500 ms. A time period of delta t=300 ms has proven to be particularly suitable for determining that the position of the object is constant. For the purposes of the invention, the wording that a “velocity is essentially 0” preferably means that the velocity of the attached object is less than 10 mm/s, more preferably less than 5 mm/s and most preferably around approx. 3.7 mm/s. This corresponds to a value for the motor rotational speed of less than 1 rad/s.

In a further aspect, the invention relates to a system, wherein the system comprises an electronic module with an energy source for supplying the system with electrical energy, an apparatus for winding up the traction cable, a motor for driving the apparatus for winding up the traction cable, and a control device. It is preferred for the purposes of the invention that the system, in particular the control device thereof, is configured to carry out a counterbalancing operation with respect to the weight force of the object. The counterbalancing operation preferably represents a control and regulating process with respect to the position of an object fastened to the traction cable of the system, it being possible for this control and regulating process to be described by the method steps mentioned above. The term counterbalancing operation relates in particular to the counterbalancing of a weight force of an object in a system, wherein the object can be fastened to a traction cable of the system. In addition, the electronic module can comprise a transmission that is preferably configured to permit high torques of the motor.

It is preferred for the purposes of the invention that the motor, the transmission and a pulley at the output of the transmission are located on the back, i.e. in a back region of the user. The pulley may be part of or form a winding unit. The components mentioned can together form an electronic module, in which case the electronic module can also have an energy supply and a control device. The traction cable is preferably routed via guides to the front side of the user of the system. The object can be fastened to said traction cable. The object can be, for example, a drilling device or a chiseling device. It is preferred for the purposes of the invention that the weight force of the object can be counterbalanced by the system, in particular by the motor thereof, such that the user has to expend only a little force to move and work with the object. The required torque M that is to be applied by the motor to compensate for the weight force of the object can be calculated as follows:

M=−(r/i)·m·g

where m is the mass of the object, r is the radius of the pulley, g is the gravitational force, and i is the transmission ratio.

In the proposed methods, a present position of the object is first of all determined. This can be done, for example, by fastening the object to the traction cable, as a result of which a present position of the object is established. However, for the purposes of the invention, it can also be preferred that the object is first of all placed on the ground, fastened to the traction cable and brought into a present position by the system. In addition, it may be preferred for an object already fastened to the traction cable to be lowered or driven down to the ground and to be detached there from the traction cable. The present position for the purposes of the invention can preferably be the original position of the object before it was lowered or driven down. For the purposes of the invention, it can preferably also be referred to as “first position”. Alternatively, the object can then also be moved (back) again into its original position or to another position. In a further embodiment, the object which is already fastened to the traction cable can be detached from the system or the traction cable, the position at which the system registers the removal of the object being used as the first position for the purposes of the invention. Detecting whether an object is fastened to the traction cable of the system is preferably carried out by detecting a change in the rotational speed, wherein such a change in rotational speed can be caused in particular by hooking up an object. In other words, the fastening of the object to the system may result in an increase in the rotational speed, which is detected by the system and associated with the “object hooked up” information.

Controlling the position of the object preferably comprises a position control, which can be switched rigidly or softly.

This setting of the rigidity of the control can be carried out in particular depending on a rotational speed of the motor of the electronic module of the system or depending on the one derivation of the motor rotational speed. A position controller, in particular, is used for implementing the control. The position controller can be configured, for example, as a PIDT1 controller or PDT1 controller.

It is preferred, in the alternative embodiment of the invention, that a present position of the object can be stored and then used as a controlled variable in the control and regulating method if the rotational speed of the motor or a derivation thereof exceeds a certain value. This value is preferably also referred to as a “limit value” or “switching value”, said limit value or switching value being able to be, for example, in a range from 40 to 1000 rad/s for the motor rotational speed and 100 to 4000 rad/s² for the derivation of the rotational speed of the motor. Of course, values outside these ranges may also occur. This limit value can be the same or similar for the first proposed method. However, other values may also be suitable as a limit value for the first proposed method.

The control to this previously stored present position of the object, which is also referred to as the “first position” and is designated by the reference sign “X” for the purposes of the invention, is used in particular when the object is fastened to the traction cable by a user of the system. Advantageously, with the invention in this embodiment of the invention, the weight or the weight force of the object can be balanced particularly well.

In addition, within the context of the present invention, further options or modes for picking up the object can be provided. For example, the object, the weight of which is to be counterbalanced by the proposed system and with the proposed method, can be picked up horizontally from a substrate. In other words, in this first mode, the object is deposited onto a substrate, such as the ground. The object can then be fastened to the traction cable, for example using a picking-up apparatus or suspension apparatus, and lifted to a specific height. The lifting operation can be started, for example, using an input means on the system. For example, push buttons, switches, or potentiometers can be used to initiate the lifting of the object to a specific height. The use of a potentiometer is particularly preferred when a variable stroke speed or lifting speed is desired.

In one embodiment of the invention, the object, which in this embodiment of the invention is already fastened to the traction cable, can be moved in a spatial direction downward, in particular in the direction of the ground. For the purposes of this embodiment of the invention, it is particularly preferred that the object is lowered to the ground and then uncoupled.

It may also be preferred for the purposes of the invention that the user of the proposed system detaches the object from the traction cable and in this way removes the object from the system. In this embodiment of the invention, it is preferred that the picking-up or suspension apparatus or the traction cable remains at the position that it had taken up when the object was removed, so that this position of the picking-up or suspension apparatus or of the traction cable can be used as a controlled variable for the proposed counterbalancing operation.

If the rotational speed of the motor and/or a derivation thereof falls below a limit value for a certain time, the current setpoint value is stored in the system as a controlled variable. It is preferred for the purposes of the invention for the limit value or switching value to be established before the system is put into operation. For example, said value can be stored in the system. This storage can take place, for example, in the control device of the system. Storage means for storing the first or the present position of the object can also be provided in the system. Furthermore, lookup tables or similar means of comparison can be used. It is preferred for the purposes of the invention that the limit values or switching values are stored in the system.

The wording that the position of an object is used “as a controlled variable” is not an unclear term for the person skilled in the art, because the person skilled in the art knows that this means control to this position. As soon as the control process is completed, the current necessary for this purpose or the necessary torque of the motor is stored. For the purposes of the invention, these method steps are referred to as “storing a current value I_X required for balancing the attached device in the system” or “storing a torque M_X required for balancing the attached device in the system”. The current value I_X required for maintaining the first or present position is preferably the output of the position controller or the data and measured values output by the latter. The stored current and the stored torque preferably represent the values required for the system to balance the attached object. The stored current value I_X can, for example, correspond to the current setpoint value of the first proposed method.

It is preferred for the purposes of the invention that the position controller is configured to allow the object to be moved upward or downward by a user. It is preferred for the purposes of the invention that, in the event of a rigid position control, the controller responds by requesting a higher or lower torque or a higher or lower current when the user attempts to move the attached device downward or upward. This response takes place preferably promptly or immediately after the system has detected the movement of the object. Advantageously, the additional force of the user is counterbalanced and the object hooked up to the traction cable of the system remains in place. In the event of a soft position control, this request for a higher or lower torque is fed back proportionally or integrally and thus changes the setpoint value for the position.

It is preferred for the purposes of the invention that the changed current value is referred to as DELTA_I and the changed torque as DELTA_M, with the respective difference between the changed value and the initial value being able to be further processed using information technology. For the purposes of the invention, it is very particularly preferred that the current value I_X stored in method step d) or the value M_X stored in method step d) for the torque is subtracted from the respective value DELTA_I or DELTA_M, with the respective difference being able to be integrated, integrated with damping and/or PI-amplified. This can preferably provide a very soft position control, which makes it possible for the user of the proposed system to have to work with the balanced object only against very little resistance. In other words, the force that the user has to exert when working with the object, the weight of which is intended to be counterbalanced by the proposed system, can be significantly reduced. Tests have shown that the force to be applied by the user can be virtually reduced to 0. For the purposes of the invention, this preferably means that the user only has to apply the force required to work with the power tool, but not a force to hold the power tool. It is preferred for the purposes of the invention that a size of this resistance can be adjusted with the aid of amplification or an amplification control, in which case the amplification or the amplification control can be connected upstream of the integrator. It is preferred for the purposes of the invention that a difference between the changed current value DELTA_I and the stored current value I_X is integrated, wherein the setpoint value for the position can be corrected as a result. The integration can preferably be carried out by the integrator. In other words, the integrator can be configured to integrate a difference between the changed current value DELTA_I and the stored current value I_X, as a result of which a correction of the position setpoint value can be obtained.

In one exemplary embodiment of the invention, the object is fastened by the user of the system to the traction cable thereof, wherein the system is preferably in a reset state in this case. As soon as the object has settled in a fixed position, the system changes to the weak or soft position control state. This fixed position of the settled object may also be referred to as “first position X”. The first position X of the object preferably corresponds to a certain current value which is dependent on the weight of the attached object. It is preferred for the purposes of the invention that the present current value or torque value is stored and forwarded to the integrator when the state of weak or soft position control is entered. If the user of the proposed system hooks up an object to the traction cable, the rotational speed w_MOTOR of the motor or a derivation thereof div_w_MOTOR can rise rapidly as a result, with the system preferably being configured to detect an increase or a change in the motor rotational speed or the derivation of the motor rotational speed and to change to a “position control” state. The detection is preferably carried out by a comparison with reference values determined previously in tests. When this state is entered, the present position of the object is measured and subsequently adjusted thereto. It is preferred for the purposes of the invention that a few sampling steps are carried out when the rotational speed w_MOTOR of the motor falls below a specific, very small value. This very small value can be, for example, in a range of, for example, 0 to 0.1 rad/s. The system can then return to the weak or soft position control state, wherein the sampling steps can be, for example, 1 millisecond (ms) in length. For the purposes of the invention, it is preferred that 10 to 300 sampling steps are carried out. It is preferred for the purposes of the invention that, during the sampling steps, there is a wait to see whether the rotational speed w_MOTOR of the motor stabilizes at the very low level. If this is the case, the change to the weak or soft position control state follows. Preferably, the value of the motor rotational speed during the ten sampling steps, for example, is always less than a limit value, which can be 0.1 rad/s, for example.

If the proposed method includes lowering or pulling out the object, it is preferred for the purposes of the invention that the system can be in a “pull-down” or “pull_up” state, with a position setpoint value being able to be changed substantially continuously in these states. The term “substantially continuous change” is not an unclear term for the person skilled in the art, because they know that it means, for example, change rates or change steps in a range of 0.05 rad/ms. This advantageously allows the object to be able to be lifted or lowered. As soon as the user stops moving the object downward or upward, it is preferred for the purposes of the invention that a low value for the motor rotational speed w_MOTOR is reached again or a certain number of sampling steps is awaited before a return to the weak or soft position control state takes place. In this embodiment of the invention, the position controller assists the user of the system to slow down a movement of the object, with the user having to work against a slight, preferably adjustable, resistance of the object. This embodiment of the invention is particularly preferred when the object is to be lifted from a substrate, with the hooking up in particular taking place while the object is still lying on the substrate. It can also be used in cases where the object is to be lowered onto a substrate in order to be uncoupled there.

It is preferred for the purposes of the invention that the position control is carried out substantially continuously while the object is being worked with or when the object is fastened to the traction cable of the system. For this purpose, the data that are determined during the counterbalancing operation are preferably used in order to compensate for the weight force of the object. A new counterbalancing operation preferably takes place when another object is fastened to the traction cable of the system or the original object is uncoupled and hooked up again, for example due to a tool change at the object.

It is preferred for the purposes of the invention that the transmission of the system in particular has a transmission ratio between 2 and 15 and preferably between 4 and 12. In addition, the transmission can have a pulley at its output, the pulley having a diameter in a range from 10 to 200 mm, preferably in a range from 20 to 150 mm and particularly preferably in a range from 40 to 120 mm. Tests have shown that a combination of a transmission ratio in a range of 4 to 12 and a pulley diameter of 40 to 120 mm represents a good compromise so that, although the motor of the system is capable of generating a sufficiently large torque, on the other hand it can be compact in order to be used in a body-borne counterbalancing system.

It is preferred for the purposes of the invention that the motor is an external rotor motor. Advantageously, high torques can be achieved at low rotational speeds by using an external rotor motor.

In addition, it is preferred for the purposes of the invention that the motor has a number of poles greater than 6. This makes it possible to provide a continuously high torque.

### Compensation for Movements of the User:

It is preferred for the purposes of the invention that forces act on the object as a result of movements by the user, with said forces and the effects thereof on the weight force of the object being able to be counterbalanced by positive or negative changes in the torque of the motor of the system. For the purposes of the invention, the term “positive change in the torque” is preferably understood as meaning an increase in the torque, while the term “negative change in the torque” is preferably understood for the purposes of the invention as meaning a reduction in the torque. In other words, changes in the torque can be used to counterbalance movements of the user who is connected to the object via the system. In this way, in particular, undesired, uncontrolled movements of the object that may pose a risk to the system user can be prevented.

Movements of the user that can be counterbalanced using the proposed system are, in particular, the following:
up and down movement caused by motion of the user, in particular running,
bending movements of the user in a spatial direction forward or backward,
bending movements of the user in lateral spatial directions (“sideways”),
rotational movements of the user around a vertical body axis.

It is preferred for the purposes of the invention that in particular the up and down movement caused by motion of the user, in particular running, and the bending movements of the user in a spatial direction forward or backward can be counterbalanced by the proposed system and with the proposed method. This is preferably done by additional accelerations that act on the object and affect the weight force thereof. In other words, the object can be subjected to additional accelerations in order to counterbalance movements by the user. Preferably, these additional accelerations counteract the movements of the user, i.e. they are suitable for counterbalancing the movements of the user. It is preferred for the purposes of the invention that these additional accelerations can be counterbalanced by positive and negative changes in the torque. The proposed system preferably has acceleration sensors that are configured to determine these additional accelerations. For the purposes of the invention, it is preferred that use is made of acceleration sensors which can measure the acceleration primarily on the Z axis. For the purposes of the invention, a movement of the object along the Z axis corresponds to an up and down movement of the object. This axis is shown, for example, in FIG. 1 as the O or U axis. In addition, the acceleration sensors are preferably configured to also detect movements of the object on the X and/or Y axis. These movements correspond to lateral movements of the object or to movements of the object forward or backward. Furthermore, rotation rate sensors which can detect bending movements can be used. The rotation rate sensors are preferably configured to detect such bending movements in all three spatial directions X, Y and Z.

It is preferred for the purposes of the invention that the at least one sensor for detecting the acceleration is arranged in a vertical spatial direction. If the acceleration sensor is not arranged exactly in the vertical direction, it is preferred for the purposes of the invention that a correction factor is used to compensate for this deviation from the vertical spatial direction. In this case two sensors are preferably used. Preferably, the correction factor can be determined depending on the inclination angle beta of the bending movement of the user forward or backward. The vertical spatial direction preferably corresponds to a movement of the object along the Z axis (see FIG. 1: O and U axis), i.e. preferably an up and down movement of the object.

The angle of inclination beta is preferably the angle that is enclosed by an imaginary vertical axis, which runs, for example, through the system user and substantially parallel to their spine, and the inclined upper body of the user. For example, if the user bends forward by 20 degrees, starting from the usual straight posture, which is represented by the imaginary vertical axis, then the angle of inclination beta is 20 degrees. In other words, it is preferred for the purposes of the invention that the user's bending movements in a spatial direction forward or backward can be described by an angle of inclination beta. Preferably, the angle of inclination beta can take place through a frequency-based complementary filter of the rotation rate and acceleration measurement, with the frequency preferably being determined in such a way that it effectively damps a user's stepping frequency. Tests have shown that the frequency is preferably in a range of 0.4 to 2 Hz in order to achieve particularly good damping of the user's stepping frequency.

For the purposes of the invention, it is very particularly preferred that sensors are used that are configured to detect both a rotation rate and an acceleration. For the purposes of the invention, the term “rotation rate” is to be understood as meaning the bending speed of the user, i.e. the speed at which the user bends forward or backward.

By using a sensor that can detect both a rotation rate and accelerations, it is possible in particular to avoid the undesired allowance for a drift, which allowance may occur when using pure rotation rate sensors.

For the purposes of the invention, it is preferred that the system comprises at least one sensor for detecting a position of the motor of the balancing apparatus. In particular, a position of the rotor of the motor can be determined by the sensors if the motor of the apparatus is designed as an electric motor, which preferably comprises a rotor and a stator. The at least one sensor for detecting the motor position can preferably be designed as a Hall sensor. In particular, the system is configured to determine a speed of the motor. This determination of the motor speed preferably takes place depending on the determined position of the motor or of the rotor thereof. For the purposes of the invention, it is very particularly preferred that a motor speed is determined and made available to the balancing apparatus for controlling or adjusting the position of the attached object. The motor speed can preferably be determined using the Hall sensor. It is preferred for the purposes of the invention that the balancing apparatus is configured to determine that motor current which is required to control the position and/or the weight of the attached object. This determination of the motor current can take place in particular depending on a set or determined operating mode of the system. It is preferred for the purposes of the invention that the balancing apparatus is capable of detecting whether a load is attached or hooked up to the system. This detection is preferably based on the motor speed, which can be determined, for example, with the Hall sensor.

For the purposes of the invention, it is very particularly preferred that, when detecting whether an object is attached, the motor current required to keep the object in suspension is determined. For the purposes of the invention, the wording “to keep in suspension” preferably means that a weight force of the object is counterbalanced or neutralized by a holding force or tensile force of the system. Within the context of the present invention, this state is preferably referred to as the balancing or equilibrium state. It is preferred for the purposes of the invention that the holding force or pulling force that is required to counterbalance the weight force of the object can be generated by the motor of the system. In other words, the motor of the system can be used to counterbalance the weight force of the object. The motor current is preferably regulated with the aid of a motor controller or with the aid of motor electronics. It is preferred for the purposes of the invention that the system has at least one further sensor, wherein this additional sensor is provided for determining the motor current. The further sensor can therefore preferably also be referred to as a current sensor.

It is a substantial advantage of the invention that the current or a current value for the new position of the object can be readjusted such that the user can move the object without applying the actual weight force if the position of the object is changed by the user by lifting or lowering the object.

It is preferred for the purposes of the invention that the position of the attached object can be controlled via an input device. The input device may include, but is not limited to, a display, a touch screen, buttons, switches, controls, and/or other actuating elements. The wording that the “position of the attached object can be controlled via an input device” means for the purposes of the invention that the input device can have, for example, an “up switch” and a “down switch”, with actuation of the up switch preferably resulting in the object being pulled upward by the system, while actuation of the “down switch” results in the object being lowered by it moving downward. In addition, the input device may include an on/off switch that can be used to switch the system on or off. Furthermore, the input device can comprise output means, such as light emitting diodes (LEDs), with which, for example, a readiness for use of the system or a state of charge of the battery of the system can be displayed. For this purpose, the LEDs can, for example, have different colors or can emit or flash light in different colors. It is preferred for the purposes of the invention that forces caused by other movements of the user can be counterbalanced by similar or analogous methods.

The system can be operated in different operating modes. One possible operating mode relates, for example, to uncoupling or removing the object. For the purposes of the invention, this mode is referred to as an “unhook” or uncoupling mode.

It is preferred for the purposes of the invention that the position of the object is fixed in the uncoupling mode, such that the object can be removed from the traction cable of the system in a particularly simple and force-free manner. The uncoupling module thus makes it easier for the user to uncouple the object or to remove the object from the system. Advantageously, when uncoupling the object, the user does not have to apply the weight force of the object, but rather this is removed from the user by the system. It is preferred for the purposes of the invention that the present position of the object in the uncoupling mode is controlled independently of the attached load, i.e. the weight of the object.

The various operating modes of the system can be set using the input device, for example. For example, the input device can have different keys, switches or buttons, wherein the individual operating modes are switched on or off by actuation of a switch or a plurality of switches. It can also be preferred for the purposes of the invention that the input of a specific key combination or a sequence of keys in a specific order can be used to switch operating modes on or off. In an exemplary embodiment of the invention, the uncoupling module can be switched on, preferably by simultaneously pressing the “up” and “down” buttons of the input device. The input device can also have LEDs that can be used to indicate that a specific operating mode is switched on. For example, a specific LED can flash or change color in this case. The various operating modes can also be deactivated using the input device. For example, individual keys or key combinations can be actuated to deactivate the uncoupling mode. Another mode of operation of the system is, for example, the balancing state or counterbalancing state or mode.

### Compensation for Actual Forces:

When the user of the system works with the object, i.e. for example chisels or drills a hole, part of the weight force of the object is absorbed by the substrate that the object is working on. This absorption of force by the substrate being worked on can lead to the object being pulled upward because the reduced weight force of the object is not compensated for in any other way. Without appropriate countermeasures, the user would now have to work by means of a force downward counter to the upwardly acting tensile force. This can be prevented if the system comprises a force sensor or a torque sensor, the force sensor being configured to detect the force on the traction cable (“cable force”), while the torque sensor is configured to detect the actually acting torque. The torque sensor can preferably be arranged between a pulley of the winding unit and the transmission of the electronic module or between the motor and the transmission. It is particularly preferred for the purposes of the invention that contactless sensors are used.

It is preferred for the purposes of the invention that as much current is in each case impressed on the motor of the system as is required to compensate for the actually acting force. The actually acting force can be determined as the difference between the weight force of the object and the force absorbed by the substrate.

The system can preferably also implement overload detection. In other words, the system is configured to detect large weights, i.e. heavy loads, and to respond accordingly in order to protect itself. For example, the system can indicate an error if an object weighing more than 20 kg, for example, is fastened to the traction cable. In this case, for example, the short-circuit brake of the system that is described further below can be activated such that the object detected as being “too heavy” is carefully lowered to the floor or substrate after a short-circuit in the motor phases or the motor windings of the system motor. This effectively protects the system from excessive mechanical loads that may possibly damage the system.

### Safety in the Event of an Electronic Failure:

It is preferred for the purposes of the invention that a braking function is provided with which the object can be prevented from falling undesirably, which can happen if the power supply to the electronic module of the system is interrupted. The braking function can preferably be realized by short-circuiting the three phases of the motor of the system. This short-circuiting of the three motor phases or of the motor windings is carried out in particular when the motor is de-energized. By means of the short-circuiting, a short-circuit brake can be provided, which advantageously makes it possible for a falling velocity of the object to be minimized to uncritical values and for higher falling velocities to be ruled out. The motor phases can be short-circuited, in particular, by two relays that are switched on when the motor is in a currentless state. Another possibility is to use semiconductors that behave similarly to the relays. It is preferred for the purposes of the invention that the short-circuit brake is used, for example, when a power failure or another error in the system is detected. Preferably, the object that is attached to the system can be carefully deposited or lowered onto the floor or the substrate with the aid of the short-circuit brake. Another error can be, for example, the detection of a large load, for example a load that is greater than 20 kg. In an alternative embodiment of the invention, a mechanical brake can also be used to prevent the object from falling down quickly.

In particular, the system represents a battery-operated, body-borne counterbalancing or balancing system in which the weight force of an object is compensated for by generating a counterforce, with the counterforce being transmitted by a traction cable.

The object can in particular be a power tool with which work is to be performed. For example, it can be a chiseling device, a hammer drill, a fastening device or a similarly large and/or heavy device that is to be used, for example, to work on a wall or to drive an object to be fastened into a wall or a substrate. A person skilled in the art is familiar with such power tools.

The object or power tool can be fastened to a traction cable of the system using suitable fastening or receiving apparatuses. It is preferred for the purposes of the invention that the traction cable connects the object to an apparatus for winding up the traction cable, wherein the apparatus for winding up the traction cable is preferably provided in the region of the back structure of the system. The winding apparatus is preferably configured to extend or shorten an effective length of the traction cable. This is done as part of the counterbalancing operation, in which the weight or the weight force of the object is determined and used to set and control the effective length of the traction cable. The apparatus for winding up the traction cable can thus release the traction cable or shorten its length and in this way counterbalance or compensate for the weight force of the hooked-up object. As a result, the user of the proposed system is considerably relieved of load when working with the object because, when using the system, the user has to apply only the force required for carrying out the work, and no longer has to apply the force for holding the power tool. In other words, the counterbalancing of the weight force of the object is transferred from the user to the system, and therefore the system user is freed from this. The force which has to be applied for carrying out the work can, for example, be a pressing force in order to propel the power tool or a tool thereof into a wall or into a substrate to be worked on.

The traction cable is guided in or on a cantilever of the system in the direction of a back structure. It is preferred for the purposes of the invention that the traction cable runs from the object in the direction of a first end of the cantilever, wherein the first end of the cantilever may preferably also be referred to as the front end of the cantilever.

In a preferred embodiment of the invention, the cantilever is substantially L-shaped. The cantilever preferably comprises a back section and a head section, the back section and the head section being arranged substantially perpendicular to one another. It is preferred for the purposes of the invention that the back section of the cantilever runs substantially parallel to a spine of the system user, while the head section of the cantilever runs above or next to the user's head, substantially perpendicular to the back section and/or the spine of the user. It is preferred for the purposes of the invention that the cantilever or the head section thereof can be guided over the user's head or next to the user's head. As a result, a particularly flexible and versatile system can be provided. The transition region between the back section and head section of the cantilever can be L-shaped, can comprise a transition section or can be designed as a joint. A transition region designed as a transition section between the back section and head section of the cantilever leads to a particularly stable structure of the proposed system, while a joint that can be provided in the transition region between the back section and head section of the cantilever enables the system to be able to be folded, which means that the packing size of the folded-up system can be significantly reduced.

The terms “top”, “bottom”, “front” and “rear” do not represent unclear terms for a person skilled in the art within the context of the present invention, since the terms and the spatial directions “upward”, “downward”, “forward” and “backward” associated therewith are explained, for example, in FIG. 1. For example, the weight force of the object usually acts in a spatial direction “downward”, i.e. in the direction of the ground on which the user of the system is standing. The spatial direction “upward” corresponds to the direction in which the object is moved when the effective length of the traction cable is shortened by the traction cable winding apparatus. During normal use of the proposed system, the object is located in front of the user, for example at head, chest or stomach height. The head section of the cantilever usually represents the highest point of the system, such that in the terminology of the invention it forms the upper end of the system. The back section of the cantilever forms the rear region of the system. The back structure with the electronic module, the motor for driving the winding apparatus and the control device is provided in the rear, lower region of the system. The lower end of the system can be formed, for example, by a hip belt with which the system can be fastened on the user. For the purposes of the invention, this hip belt forms a first contact region at which there is physical contact between the system user and the system. A second contact region can be formed by a back padding.

Preferably, the cantilever of the system can be accommodated by the back structure. The system comprises an electronic module, wherein the electronic module can be arranged in particular in the region of the back structure of the system. The electronic module can be part of the proposed system.

The electronic module comprises an energy source for supplying electrical energy to the system. The energy source can be a battery or a rechargeable battery (“power pack”), wherein the power pack is preferably rechargeable. If the object, the weight of which is counterbalanced by the proposed system, is a battery- or power pack-operated power tool, it is preferred for the purposes of the invention that the energy source is similar to or the same as the energy source of the power tool. In other words, it is preferred for the purposes of the invention if substantially the same batteries and power packs can be used for the power supply of the proposed system and of the power tool.

The electronic module also comprises an apparatus for winding up the traction cable and a motor for driving said apparatus. It is preferred for the purposes of the invention that the apparatus for winding up the traction cable is arranged in a region of the back structure and the traction cable can be wound up using the motor. The motor of the proposed system is configured to generate a torque to counterbalance the weight force of the object.

The counterbalancing operation takes place in particular when a new object is fastened to the traction cable of the system. This can be the case, for example, when a power tool is exchanged because a different job is to be done. As part of the counterbalancing operation, regulation to the static weight or the weight force of the object is undertaken, with the controlled variable being in particular the current setpoint value. For the purposes of the invention, however, it may also be preferred for the counterbalancing operation to represent a substantially continuously running control and regulating process in which the motor rotational speed in particular is regulated to the “zero” rotational speed, i.e. to a standstill.

The counterbalancing operation is designed in particular as an automatic counterbalancing operation, in which the system responds preferably automatically to the weight force of the object or to changes thereof by the torque on the motor of the system being correspondingly regulated.

The electronic module also comprises a control device which is configured to carry out the counterbalancing operation with respect to the weight force of the object. Within the context of the invention, it is preferred that primarily the apparatus for winding up the traction cable, the motor and the control apparatus are supplied with electrical energy.

It is preferred for the purposes of the invention that a counterforce for the weight force of the object is determined during the counterbalancing operation, such that the weight force of the object is counterbalanced or compensated for by the counterforce acting in the opposite direction to the weight force. Preferably, the counterforce can be transferred to the object using the traction cable. As a result, the weight of the object can be “removed” from a user of the system, such that the user—for example while working with the object—does not have to hold the latter at a certain height, but rather only has to apply the force that is required to do the specific work to be done with the object.

For the purposes of the invention, it is preferred that the traction cable is guided by means of pulleys and/or a Bowden cable. The Bowden cable can in particular comprise a Bowden cable or can be formed by one. It is preferred for the purposes of the invention that the traction cable is guided in or on the cantilever and thus leads from the object to be held, the weight of which is to be compensated, to the winding apparatus.

It is preferred for the purposes of the invention that the back structure comprises a first contact region and a second contact region, wherein contact between the user of the system and the system is provided at least in the contact regions. The first contact region can preferably be designed as a hip belt, while the second contact region can be designed as back padding. It is preferred for the purposes of the invention that the weight of the system can be optimally transferred to a stable body region of the system user by using a hip belt as the first contact region. In other words, a large proportion of the weight of the system is admitted to the hip belt and distributed by the latter to a stable body region of the user. As a result, the wearing comfort of the proposed system can be significantly increased.

A distance between the first contact region and the second contact region is preferably designed to be adjustable in order to adapt the system to the user and to counterbalance a tilting moment caused by the object. This tilting moment preferably acts in the spatial direction “forward”, such that the user of the system can be pulled in the spatial direction “forward” when using the system and in particular when a heavy object is fastened to the traction cable. In order to optimally counterbalance said tilting moment, it is preferred for the purposes of the invention that the distance between the first contact region and the second contact region of the back structure of the system is chosen to be as large as possible in order to achieve good leverage. This is made possible in particular by the adjustability of the distance between the first contact region and the second contact region of the back structure.

In particular, the proposed system has a linear guide that can be used to adjust the distance between the back padding and the hip belt. In this way, the user can set a respectively possible maximum distance between the first and the second contact region of the back structure, in a manner adapted to the user's height. The linear guide thus makes a significant contribution to compensating for the tilting moment by the object, the weight of which is to be counterbalanced by the system.

It is preferred for the purposes of the invention that the system has a strut in order to introduce a tilting moment caused by the object into a first contact region of the system. Preferably, the tilting moment is directed in particular into the hip belt of the system, where it is distributed over a stable body region of the user. The conducting away of the tilting moment can be further improved by the provision of the strut. For the purposes of the invention, it is preferred that the strut connects the back structure to the hip belt. The strut can be reinforced with a flexible plate to improve the introduction of force into the hip belt.

It is preferred for the purposes of the invention that the cantilever is designed to be foldable. For this purpose, the cantilever can comprise at least one joint.

In a first aspect, the invention thus relates to a system that can be carried by a user in the manner of a rucksack, the system having a cantilever which runs above the head of a user when the system is used, with a traction cable being able to be guided on the cantilever. An object can be attached or fastened to the traction cable, the weight force of which object can be counterbalanced with the aid of the system. The object can in particular be a power tool with which a user can carry out applications such as drilling, chiseling, hammering, etc. From a technical point of view, the counterbalancing of weight forces in a moving object, such as a power tool that is being worked with, represents a different challenge than transporting an object from a first position to a second position with the aid of a traction cable. With the proposed system, not only objects with a static, i.e. constant weight force can advantageously be moved or raised or lowered. Rather, the proposed system is configured to respond to a dynamic change in the weight force of the object and to adapt the tensile force or holding force to the change. In this way, the work with the object or the power tool can be considerably simplified for the user of the system. In particular, the invention differs from the prior art, in which objects can be transported by a traction cable system, by the capability to adapt the tensile force or holding force to a dynamically changing weight force. The adjustment of the tensile force or holding force to a dynamically changing weight force of a coupled object can preferably be carried out by determining a rotational speed of the motor or a derivation thereof, and a current setpoint value. In this case, the weight force of the object can then be counterbalanced using the determined current setpoint value.

In a further aspect, the invention can relate to a stand-alone solution in which the electronic module can be deposited on a substrate, for example. In such a system, the traction cable can be guided via traction pulleys, which can be attached, for example, to a ceiling, ceiling beams, struts or pillars on a construction site.

In a further aspect, the invention thus relates to an electronic module for counterbalancing a weight force of an object. The terms, definitions and technical advantages introduced for the proposed system and the components thereof preferably apply analogously to the electronic module. Within the context of the electronic module, the object, the weight force of which is to be counterbalanced, is fastened to the module with a traction cable. The electronic module has the following components for counterbalancing a weight force of an object:
an energy source for supplying the system with electrical energy,
an apparatus for winding up a traction cable,
a motor for driving the apparatus for winding up a traction cable, and
comprises a control device,
   wherein the control device is configured to carry out a counterbalancing operation with respect to the weight force of the object.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations. Identical and similar components are denoted by the same reference signs in the figures, in which:

FIG. 1 shows a view of a preferred embodiment of the proposed system

FIG. 2 shows a view of a preferred embodiment of the proposed system with a length-adjustable back structure

FIG. 3 shows a schematic view of a preferred embodiment of the proposed system.

### DETAILED DESCRIPTION

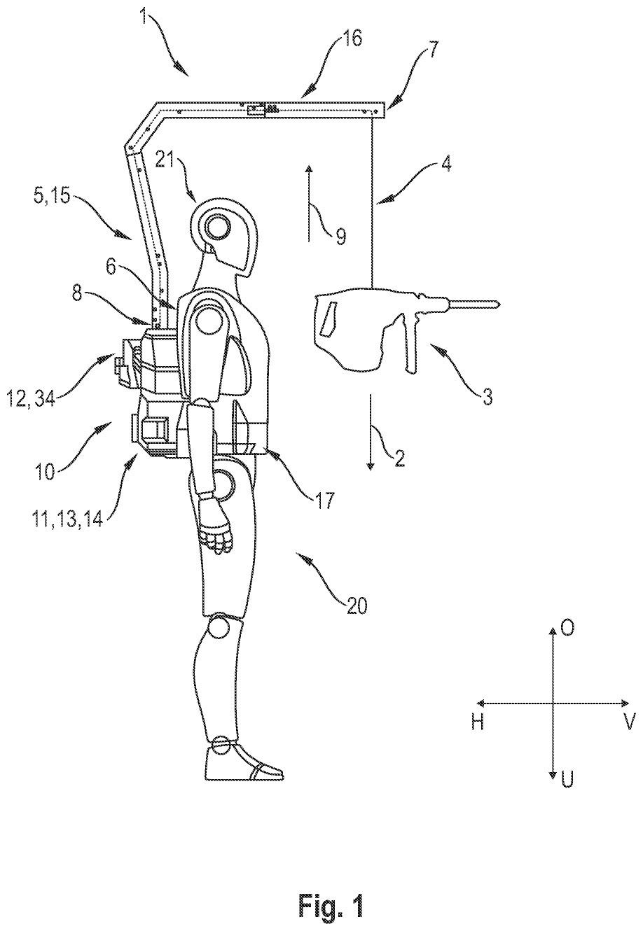

FIG. 1 shows a preferred embodiment of the proposed system 1, which is carried by a user 20. The system 1 comprises a cantilever 5 which runs above the head 21 of the user 20 in the example of the invention shown in FIG. 1. The cantilever 5 can have sections which are referred to as the back section 15, head section 16 and transition section. The back section 15 is arranged in a back region or rear region of the system 1 and runs substantially parallel to a spine of the user 20. The head section 16 runs substantially perpendicularly to the back section 15 of the cantilever 5, such that the back section 15 and the head section 16 substantially enclose a right angle. The cantilever 5 can be L-shaped or have a transition region which has a transition section arranged obliquely between the back section 15 and the head section 16. The cantilever 5 has a front or first end 7 and a second or rear end 8 which opens into the back structure 6 of the system 1. The back structure 6 makes it possible for the user 20 to carry the system 1 on their back. An electronic module 10 that contains various components of the system 1 is provided in the back region of the user 20. In particular, an energy source 11, an apparatus 12 for winding up a traction cable 4, a control device 14, and a motor 13 are accommodated in the electronic module 10. The apparatus 12 for winding up the traction cable 4 can comprise a pulley which is arranged at the output of a transmission 34. The transmission 34 can also be part of the electronic module 10. The back structure 6 or the electronic module 10 can be fastened on the user 20 with a first contact region 17 and a second contact region 18. The first contact region 17 can be designed as a hip belt, while the second contact region 18 is preferably designed as back padding. An object 3 having a weight force 2 can be fastened to the traction cable 4. The weight force 2 is preferably the weight of the object 3, wherein the weight force 2 points in the direction of the ground. For the purposes of the invention, this direction is preferably referred to as the “downward U” spatial direction. The other spatial directions “upward O”, “forward V” or “backward H” are also shown in FIG. 1. The downward arrow, which is provided with the reference sign 2, symbolizes the weight force 2 of the object 3 and indicates its direction. The object 3 can preferably be in the form of a power tool and can be fastened to the system 1 via the traction cable 4. Simple fastening means, such as snap hooks, or special fastening means or receiving devices can be used for this purpose.

The traction cable 4 leads from the object 3 in the direction of the cantilever 5 and is then guided in or on the cantilever 5 in the direction of the back structure 6 or the electronic module 10. The winding apparatus 12 with which the traction cable 4 can be wound up is located in the electronic module 10. As a result, the effective length of the traction cable 4 can be extended or shortened. In particular, the length of the traction cable 4 can be adapted to the weight force 2 of the object 3, wherein the weight force 2 of the object 3 is determined in a counterbalancing operation. The winding apparatus 12 is driven by a motor 13 which can also be arranged in the electronic module 10. It is preferred for the purposes of the invention that the counterbalancing operation represents a regulating and control process, the aim of which is that the motor 13 is at a standstill. In other words, the motor 13 is regulated to a rotational speed of zero by the counterbalancing operation. With the counterbalancing operation, the proposed system 1 enables a weight force 2 of the object 3 to be compensated for, such that the proposed system 1 can preferably also be referred to as a balancing system. The weight force 2 is preferably compensated for by an interaction between the winding apparatus 12, the motor 13, and the control device 14, wherein the mentioned components of the system 1 are supplied with electrical energy by the energy source 11. The energy source 11 is preferably a battery or a power pack. The weight force 2 of the object 3 is compensated for in particular by a counterforce 9 which is exerted on the object 3 and transmitted to the object 3 by means of the traction cable 4. In other words, the counterforce 9 counterbalances the weight force 2 of the object 3 and thus ensures that the user 20 of the system 1 does not have to hold the object 3 against gravitational force, but has to apply only the force required to work with the object 3. As a result, the system 1 can make the work with the object 3 much easier for the user 20. The counterforce 9 is marked in the figures with an arrow in the spatial direction “upward” and the reference sign 9.

A counterbalancing operation takes place in particular when a (new) object 3 is fastened to the traction cable 4 or when the object 3 is exchanged. In particular, the compensation for the weight force 2 of the object 3 can be regulated statically to the weight thereof. However, it can also be preferred for the purposes of the invention that the counterbalancing operation takes place continuously and that the counterforce 9 is dynamically adapted to changes in the weight force 2 that may occur briefly when working with the object 3.

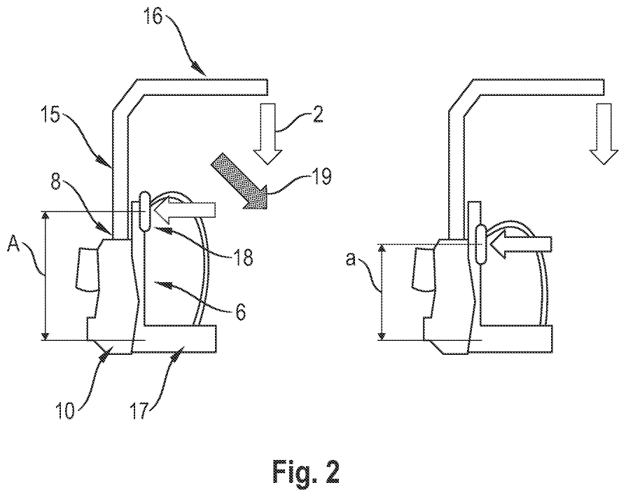

FIG. 2 shows a preferred embodiment of the proposed system 1 with a length-adjustable back structure 6. In particular, in the exemplary embodiment of the invention shown in FIG. 2, a distance A between the first contact region 17 and the second contact region 18 of the back structure 6 can be set. For the purposes of the invention, it is very particularly preferred that the distance A between a hip belt 17 and a back padding 18 of the back structure 6 can be adjusted. Owing to the adjustability of the distance A between the hip belt 17 and the back padding 18, a tilting moment 19 generated by the object 3 can be compensated for. The tilting moment 19 is shown in FIG. 2 with a hatched arrow and the reference sign 19. The tilting moment 19 is caused by the weight force 2 of the object 3, which pulls the system 1 in the spatial direction U downward. As a result, a tilting moment 19 acts overall, which acts downward and forward and in particular pulls the cantilever 5 of the system 1 in this direction. It has been shown that a particularly large distance A between the hip belt 17 and the back padding 18 as the contact surfaces between the back structure 6 and the user 20 counterbalances this tilting moment 19 particularly effectively, since particularly good leverage conditions prevail in this way. The left half of FIG. 2 shows a large distance A between hip belt 17 and back padding 18, which is symbolized by a capital letter A, while the right half of FIG. 2 shows a small distance a between hip belt 17 and back padding 18, which is symbolized by a lowercase letter a. In addition, the individual sections 15, 16 of the cantilever 5 are shown in FIG. 2, wherein the cantilever 5 can comprise a back section 15, a head section 16, and a transition section. While the back section 15 and the head section 16 are arranged substantially perpendicularly to one another, the transition section is present in a transition region between the back section 15 and the head section 16 of the cantilever 5. The adjustability of the distance A can be made possible in particular by the provision of a linear guide.

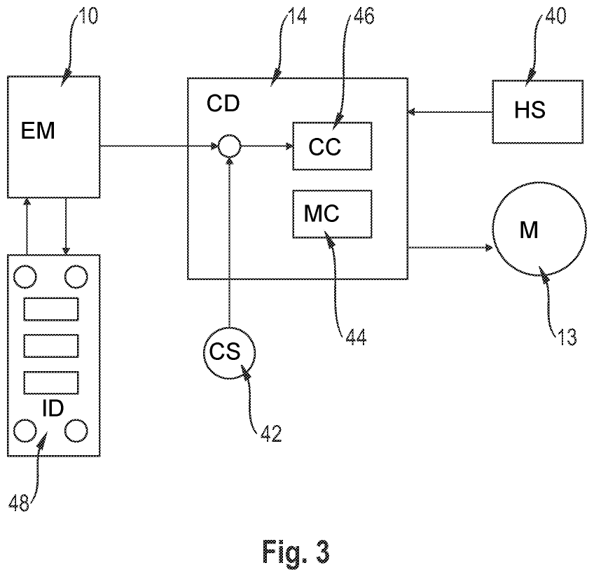

FIG. 3 shows a schematic view of a preferred embodiment of the system 1. The system 1 has an electronic module 10 and a control device 14, wherein the electronic module 10 of the system 1 provides in particular the weight counterbalancing function of the system 1. For this purpose, the electronic module 10 can send control commands to the control device 14, which can in particular include information regarding the motor current to be set. For example, the information and control commands that are passed on from the electronic module 10 to the control device 14 can include current values to counterbalance the weight of the object 3 and/or current values for the position of the object 3.

In the exemplary embodiment of the invention shown in FIG. 3, the control device 14 comprises a motor controller 44 and a current controller 46. The current controller 46 can in particular be a control device for the current of the motor 13 of the system 1. The incoming control commands from the electronic module 10 are further processed by the control device 14 in the sense that they are passed on to the motor controller 44 via the current controller 46. The motor controller 44 is preferably configured to control the motor 13. Another input variable of the control device 14 is the data from the current sensor 42, which can be further processed by the control device 14 or by the current controller 46. Data from the Hall sensor 40 is also sent to the control device 14. The control device 14 is configured in particular to evaluate the incoming signals from the Hall sensor 40 and to forward control commands from the electronic module 10 in order to control the motor 13 of the system 1. Of course, the control device 14 can also be part of the electronic module 10 or can be integrated in the electronic module 10. In particular, the control device 14 can forward the evaluated data and information from the Hall sensor 40 to the electronic module 10. This data and information can in particular be the speed of the motor 13 and/or a position of the motor 13 or of the rotor thereof (not shown). The speed of the motor 13 can be indicated in particular in the unit rad/s, while the position of the motor 13 or of the rotor thereof can be indicated in the unit rad.

The system 1 may comprise an input device 48. An input can be made by the user 20 at the input device 48. To this end, the input device 48 can comprise keys, switches, buttons and other input means, which are shown in FIG. 3 as rectangular components of the input device 48. The input device 48 can also be configured to output information. For this purpose, the input device 48 can comprise displays and/or LEDs, which are shown in FIG. 3 as round or circular components of the input device 48.

### LIST OF REFERENCE SIGNS

1 System
2 Weight force
3 Object
4 Traction cable
5 Cantilever
6 Back structure
7 First, front end of the cantilever
8 Second, rear end of the cantilever
9 Counterforce
10 Electronic module
11 Energy source
12 Apparatus for winding up the traction cable
13 Motor
14 Control device
15 Back section of the cantilever
16 Head section of the cantilever
17 First contact region, hip belt
18 Second contact region, back padding
19 Tilting moment
20 User
21 User's head
34 Transmission
40 Hall sensor
42 Current sensor
44 Motor controller
46 Current controller
48 Input device
A Distance
V Front
H Rear
O Top
U Bottom
X Present position of the object

1-13. (canceled)

14: A method for counterbalancing a weight force of an object in a system, the object fastenable to a traction cable, the method comprising the steps of:
a) fastening the object to the traction cable;
b) determining a rotational speed of the motor or a derivation of the rotational speed of the motor;
c) determining a current setpoint value; and
d) counterbalancing the weight force of the object using the previously determined current setpoint value.

15: A method for counterbalancing a weight force of an object in a system, the object fastenable to a traction cable, the method comprising the steps of:
a) determining a first position of the object;
b) determining a rotational speed of the motor or a derivation of the rotational speed of the motor;
c) storing the first position as a controlled variable in the system if the rotational speed of the motor or the derivation of the rotational speed of the motor exceeds a limit value;
d) controlling a present position of the object until a velocity of the object is zero for a period of time delta t;
e1) storing a current value I_X required for maintaining the first position in the system or
e2) storing a torque M_X required for maintaining the first position in the system; and
f) counterbalancing the weight force using the current value I_X stored in step e1 or the torque M_X stored in step e2.

16: The method as recited in claim 14 wherein the rotational speed of the motor corresponds to a velocity of the traction cable.

17: The method as recited in claim 14 further comprising a braking function in order to prevent an undesirable falling of the object.

18: A system for carrying out the method as recited in claim 14, the system comprising:
an electronic module having
an energy source for supplying the system with electrical energy;
a winder for winding up the traction cable;
a motor for driving the winder for winding up the traction cable; and
a controller.

19: The system as recited in claim 18 wherein the electronic module has a transmission with a transmission ratio between 2 and 15.

20: The system as recited in claim 19 wherein the transmission ratio is between 4 and 12.

21: The system as recited in claim 18 wherein the electronic module has a transmission with an output pulley, the output pulley having a diameter in a range from 10 to 200 mm.

22: The system as recited in claim 21 wherein the output pulley has a diameter in a range from 20 to 150 mm.

23: The system as recited in claim 22 wherein the output pulley has a diameter in a range from 40 to 120 mm.

24: The system as recited in claim 18 wherein the motor is an external rotor motor.

25: The system as recited in claim 18 wherein the motor has a number of poles greater than 6.

26: The system as recited in claim 18 further comprising at least one sensor for detecting an acceleration or a rotation rate.

27: The system as recited in claim 18 further comprising at least one sensor for detecting a position of the motor or a sensor for determining the motor current.

28: An electronic module for carrying out the method as recited in claim 14, the electronic module comprising:
an energy source for supplying the system with electrical energy;
a winder for winding up the traction cable;
a motor for driving the winder for winding up the traction cable; and
a controller.

29: The electronic module as recited in claim 28 further comprising a transmission.
